(19) United States
(12) Patent Application Publication
(10) Pub. No.: US 2008/0003409 A1
(43) Pub. Date: Jan. 3, 2008

(54) HINGE-TYPE THREE DIMENSIONAL PAPER PATTERN EMBOSSER

(76) Inventor: Yeqing Deng, Dongguan City (CN)

Correspondence Address: MORRISS OBRYANT COMPAGNI, P.C., 734 EAST 200 SOUTH, SALT LAKE CITY, UT, 84102, US

(21) Appl. No.: 11/740,824

(22) Filed: Apr. 26, 2007

(30) Foreign Application Priority Data
Apr. 26, 2006 (CN) CN 200620058230.4

(51) Int. Cl. B32B 3/00

(52) U.S. Cl. 428/172

(57) ABSTRACT

This utility model reveals a hinge-type three dimensional paper pattern embosser, which comprises two flat plastic sheets, with one side of each connected to form the hinge structure. There are interlocking groove and cam in the mutually jointing surfaces of the two flat plastic sheets, and the contour lines of the groove and cam are processed into pressed edges for pattern embossing. The two plastic sheets are interconnected by the plastic foil. This hinge-type three-dimensional paper pattern embosser can be used for creating vivid and lively three dimensional paper emboss work with obvious sense of layer with similar effect of the three-dimensional relief. Having fine decorative effect, the vividly created emboss work inspires and improves the cognition and distinction abilities of children. The hinge-type three-dimensional paper pattern embosser has compact configuration, shape, and volume leading to convenience in packaging, storage and moving. It can be put into mass production with the injection molding technique. With high production efficiency, rapid processing, and low manufacturing cost, this product is suitable for large scale promotion of application.

### TECHNICAL FIELD

The utility model relates to the pattern paper embossing fittings, more particularly, a hinge-type three-dimensional paper pattern embosser

### TECHNOLOGICAL BACKGROUND

The traditional paper-cut artwork is a popular, diverse and highly enjoyable art form for many people, especially for children in early-stage studies. Outside China, there are many countries applying this kind of art for child learning. For example, in the United States, pattern and paper-cut products are very popular. People usually apply paper sheet, plastic, rubber or similar materials to cut into letters, cartoon, animals or human beings to train the cognition and distinction of children. However, traditional handmade image products are lower in efficiency and poorer in coincidence without the capability for mass production. In order to overcome such deficiency, people invented a new method for large scale production by manufacturing an image cutter initially. They bent a thin and sharp blade into an image shape and then fix it onto a piece of wood. Later, they apply this cutter consequently to paper sheet or some other flat materials to produce identical images. If they want to generate another image product, they only have to change to a different cutter, as P.R. China Utility Patent No. 01209608.3 disclosed. This kind of pattern cutter can produce a large amount of paper-cut patterns, although the demerits are: (1) Difficulty in the production of the thin blade having the same contour of the pattern and time-consuming of the production lead to high manufacturing cost; (2) The pattern cutter should be used on top of flat plate made of non-rigid materials (such as plastic materials like PP, PC, ABS, AS, nylon 66, etc) to ensure the lowest level of damage to the cutting edge of the blade during the normal cutting of flat materials. Thus the operation requirements are higher and inconvenient is usage; (3) The paper patterns cut by the pattern cutter are only in flat, lack of three dimensional effect, not vivid in appearance and cannot present the sense of layer of the patterns.

### CONTENT OF THE UTILITY MODEL

The objective of this Utility Model is to overcome imperfectness of existing technologies and provide a reasonable, simple-structured, low cost, easy-to-use pattern paper embosser able to press and cut out paper patterns possessing strong three dimensional effects, vivid and lively images with clear layers.

The objective is achieved by employing the following techniques: The hinge-type three-dimensional paper pattern embosser comprises two flat plastic sheets, and one side of each plastic sheet is interconnected to form the hinge structure. Interlocking groove and cam are made in the mutually jointing surfaces of the two flat plastic sheets according to each particular pattern, and the contour lines of the groove and cam are made as pressed edges for the embossment.

The two flat plastic sheets are connected by a thin piece of plastic foil, with the hinge action enabled by the bending of the elastic plastic foil. The flat plastic sheets and the plastic foil can be manufactured in one-piece by the injection molding technique. The thickness of the two flat plastic sheets can be 0.6˜6 mm; the plastic foil can be designed to a width of 0.4˜0.8 mm and a thickness of 0.1˜0.4 mm.

The height of cam or depth of the groove generally can be 0.2˜0.5 mm.

The clearance between the cam and groove generally can be 0.07˜0.3 mm, and the specific clearance shall be determined based on the thickness of paper and sheet materials. In this way, the paper or materials can be easily pressed with tidy edges without cracks or unclear edges.

The distance between the position of cam and position of groove closest to the buckling edge of the plastic foil and the buckling edge of the plastic foil shall be more than 3 mm.

The material of the flat plastic sheets and plastic foil can be PE, PS, PVC, PP, ABS and other plastic materials.

Operation of the utility model is: open the two flat plastic sheets of the hinge-type paper pattern embosser, insert the paper or other flat materials for the emboss work on one of the flat plastic sheet. Fold another flat plastic sheet and apply compression. The groove and cam of the two flat plastic sheets will interlock, pressing on the paper or the flat material inserted and the emboss work having the same contour with the pattern on the two flat plastic sheets will be done.

Compared with existing technology, the utility model has the following merits and effects: (1) Vivid and lively three dimensional paper emboss work made with this hinge-type three-dimensional paper pattern embosser has obvious sense of layer with similar effect of the three-dimensional relief and is highly decorative. The vividly created emboss work inspires and improves the cognition and distinction abilities of children. It overcomes the imperfectness of existing pattern cutters cutting only the simple, external contour line of the patterns; (2) The hinge-type three-dimensional paper pattern embosser has compact configuration, shape, and volume leading to convenience in packaging, storage and moving. It overcomes the imperfectness of the existing pattern cutters which are having large sizes and is suitable to family use; (3) The hinge-type three-dimensional paper pattern embosser itself can complete the embossing by pressing on the paper itself which does not require additional back plate for cooperation purpose, and therefore, simple and convenient in usage; (4) The hinge-type three-dimensional paper pattern embosser can be put into mass production with the injection molding technique. With high production efficiency, rapid processing, and low manufacturing cost, this product is suitable for large scale promotion of application.

### BRIEF DESCRIPTION OF THE DRAWINGS

FIG. 1 is the structural representation of the utility model of the hinge-type three-dimensional paper pattern embosser.

FIG. 2 is the schematic cross section of the hinge-type three-dimensional paper pattern embosser shown in FIG. 1.

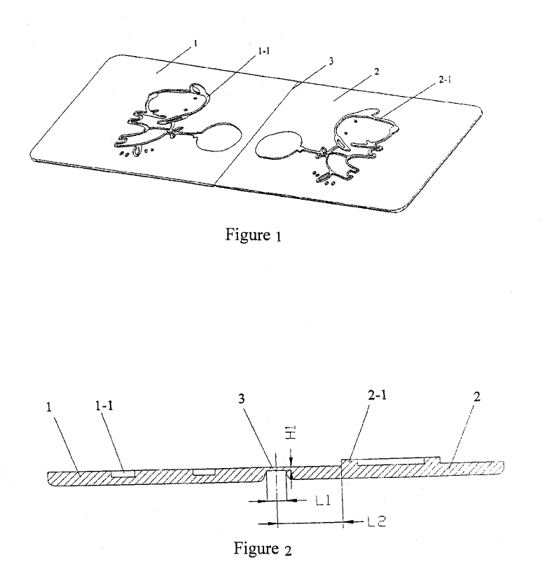

In FIG. 3, (A)˜(D) show the operation process of the hinge-type three-dimensional paper pattern embosser shown in FIG. 1; (E)˜(H) are the schematic cross section figures corresponding to (A)˜(D).

### DETAILED DESCRIPTION OF THE OPERATION

Following is a detailed description about the utility model based on example with drawings, although the operation process of the utility model is not limited to this:

### Operation Example

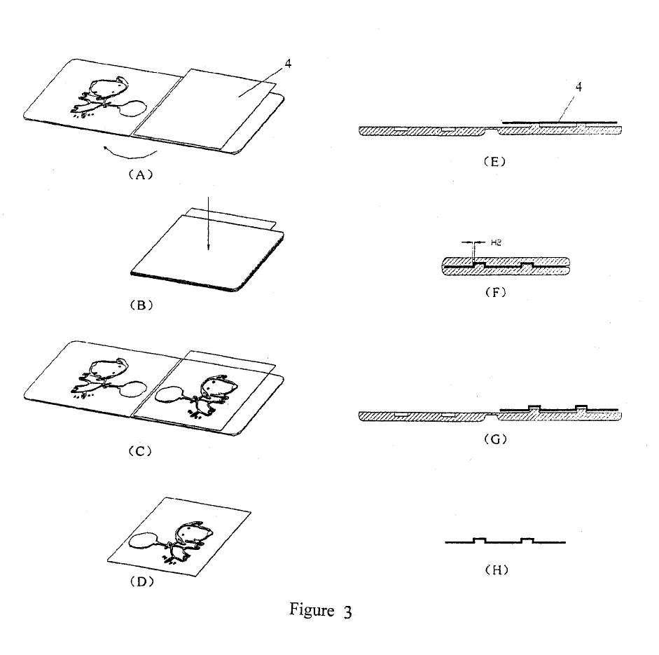

FIG. 1 and FIG. 2 illustrate the concrete structure of the utility model. From FIG. 1 and FIG. 2, the hinge-type three-dimensional paper pattern embosser comprises of two flat plastic sheets 1 and 2, one side of each plastic sheet 1 and 2 is connected with the plastic foil 3, and the hinge action is formed by folding up the two plastic sheets connected by the elastic plastic foil. The two plastic sheets 1 and 2 and plastic foil 3 can be manufactured in one-piece by injection molding technique. There are interlocking groove 1-1 and cam 2-1 on the jointing surfaces of the two flat plastic sheets 1 and 2 according to the pattern (a dog fastened with a balloon), the contour lines of the grove 1-1 and cam 2-1 are made into pressing edges for the pattern. The thickness of the two flat plastic sheets 1 and 2 is 3 mm; for the plastic foil 3, the width L1 is 0.6 mm and the thickness H1 is 0.2 mm; the height of the cam 2-1 or the depth of the groove 1-1 is 0.2 mm; the clearance H2 between the cam 2-1 and the groove 1-1 is 0.1 mm. In this way, the paper or other sheet materials can be easily embossed with tidy edges without cracks or unclear edge lines. The distance L2 between the position of cam 2-1 or position of groove 1-1 closest to the buckling edge of the plastic foil 3 and the buckling edge of the plastic foil is 4 mm.

The operation process of the utility patent is shown in (A)˜(D) in FIG. 3, and the corresponding process illustrated in cross-section is shown in (E)˜(H) in FIG. 3. The process in detail is: (1) Open the two flat plastic sheets 1 and 2 of the hinge-type three-dimensional paper pattern embosser and insert paper 4 for the emboss work on the flat plastic sheet 2 as shown in (A) and (E) in FIG. 3; (2) Fold the other flat plastic sheet 1 and apply compression as shown in (B) and (F) in FIG. 3. The opposite groove 1-1 and cam 2-1 of the two flat plastic sheets 1 and 2 will interlock and press on the paper 4; (3) Open the flat plastic sheet 1, the paper 4 inserted was embossed with the pattern, attaching on the flat plastic sheet 2 as shown in (C) and (G) in FIG. 3; (4) Remove paper 4 from flat plastic sheet 2, the same pattern and contour on the two flat plastic sheets 1 and 2 has embossed on the paper as shown in (D) and (H) in FIG. 3.

The operation example above is a good operation example of the utility model, although the operation process is not limited to the example operation above. Any other changes, decorations or replacement that are not deviated from the principle and technology of this utility model shall be deemed equivalent replacement and included in the protection of this utility model.

1. A hinge-type three-dimensional paper pattern embosser, comprising;
two flat plastic sheets, one side of each of said plastic sheets connected to form a hinge structure;
an interlocking groove and a cam in mutually jointing surfaces of the two flat plastic sheets and contour lines of the groove and cam have edges that are configured for being pressed together for pattern embossing.

2. The embosser according to claim 1, wherein one side of each of the two plastic sheets forming the hinge-type three-dimensional paper pattern embosser are connected by a plastic foil.

3. The embosser according to claim 2, wherein the two flat plastic sheets of hinge-type three-dimensional paper pattern embosser and the connection plastic foil are a one-piece structure.

4. The embosser according to claim 2, wherein the thickness of the two flat plastic sheets of the hinge-type three-dimensional paper pattern embosser is 0.6˜6 mm, the plastic foil is designed at having a width of 0.4˜0.8 mm and the thickness in 0.1˜0.4 mm.

5. The embosser according to claim 1, wherein the height of cam or depth of the groove of the hinge-type three-dimensional paper pattern embosser can be 0.2˜0.5 mm.

6. The embosser according to claim 1, wherein the clearance between the cam and groove of the hinge-type three-dimensional paper pattern embosser can be 0.07˜0.4 mm.

7. The embosser according to claim 1, wherein the distance between the position of cam or position of groove of the hinge-type three-dimensional paper pattern embosser closest to the buckling edge of the plastic foil and the buckling edge of the plastic foil is more than 3 mm.

8. The embosser according to claim 2 4, wherein the material of the flat plastic sheets and plastic foil of the hinge-type three-dimensional paper pattern embosser can be PE, PS, PVC, PP and ABS materials.
